(19) United States
(12) Patent Application Publication
(10) Pub. No.: US 2014/0345427 A1
(43) Pub. Date: Nov. 27, 2014

(54) EQUIPMENT FOR MOUNTING SUPPORT TILEFRAMES FOR ELECTRICAL DEVICES

(71) Applicant: DEVEL S.R.L., Florano, MO (IT)

(72) Inventors: Matteo Gessani, Modenese (IT); Gian Luca Sciasci, Formigine (IT)

(73) Assignee: DEVEL S.R.L., Modenese (IT)

(21) Appl. No.: 14/363,787

(22) PCT Filed: Dec. 10, 2012
(86) PCT No.: PCT/IT2012/000375

§ 371 Date: Jun. 6, 2014

(30) Foreign Application Priority Data
Dec. 9, 2011 (IT) MO2011A000320

(51) Int. Cl. B25B 21/00; H02G 3/14

(52) U.S. Cl. CPC B25B 21/002; H02G 3/14
USPC 81/57.32

(57) ABSTRACT

An apparatus for mounting support tileframes for electrical devices includes a mechanism for holding the tileframe, inserted into the said tileframe or guided for holding by the user, two or more chucks, whose number varies according to the number of screws to be fixed on the tileframe, each of which is equipped with an insert for holding and directing the rotation of one of the screws, and in which the chucks are activated, simultaneously and in the same direction, either to screw tight or unscrew said screws, by means of a screwing attachment, which can be attached temporarily to the apparatus.

### FIELD OF APPLICATION

The invention here described is an apparatus used for mounting support tileframes to which electrical devices are to be fixed, that is an apparatus which allows the operator to position said tileframes easily and quickly without having to perform manual operations normally associated with this mounting procedure into the tileframe's corrected position.

### CURRENT STATE OF THE ART

The current state of the art comprises various solutions for installing or replacing electrical devices such as sockets, power points, switches, warning lights and other accessories/electrical devices, which are mounted on a support tileframe, once made of metal but now of plastic, and inserted in flush-mounted boxes of the wiring system that distributes electrical energy in houses, offices or other environments. Such solutions are designed for ease of mounting and maintenance/replacement of the said electrical accessories/devices.

Ease of access, both in mounting and subsequent maintenance, is ensured by the fact that said accessories/devices are modular in design, which means that they can mounted with the tileframe in housings and located in the wiring system as required. In current practice, depending on the various versions available for installing said accessories/devices, the tileframe is mounted prior to their installation: thus, in the flush-mounted box which houses the necessary electric cables, the mounting of the tileframe precedes that of the accessories/devices; later, after the internal wiring is completed, the accessories/devices are mounted externally by applying pressure on the support tileframe. Not infrequently, the builder creates the box housing for the electrical plant manually without paying due attention to its horizontal alignment. As a result, when the tileframe is mounted, and subsequently also accessories and devices, the operator must screw the tileframe side screws into the site of the flush-mounted box to which be fixed, while at the same time checking that the tileframe is perfectly horizontal. This is done in order to avoid further adjustment, only possible in that the screws are placed in vertically aligned holes, allowing for a few millimeters of play in order to align the tileframe horizontally. The flush-mounted boxes themselves may present a horizontal incongruity on the wall. This process of adjustment makes the work slow and laborious, since the operator must assess the precision of the tileframe mounting while performing it manually.

This procedure, though acceptable for mounting ten or so units in a circuit of limited size, proves inefficient where the operator has to mount a large volume of tileframes in order to complete extensive or multiple circuits, as happens for example in apartment houses or office blocks. It is not uncommon in this field, even with the aid of modern equipment such as electric screwdrivers, for the tileframes to be imperfectly mounted and to require subsequent adjustment to the mounting, as often happens if the tileframe is not perfectly aligned horizontally. Such non-alignment is clearly visible externally since the tileframe supports the electrical unit which forms part of the final decorative effect, to which the end-user pays particular attention.

Current technology does not as yet document a device which facilitates the operator's task so as to guarantee that the tileframe is mounted quickly and safely above the flush-mounted box which houses the electrical plant.

EP 1693154 documents an electrically powered dual-chuck screwdriver for mounting electrical plant in which drive is transmitted to the screws for fixing the box for electrical components or devices such as sockets, switches or power points for electrical energy supply. The said invention tightens the two screws in position in a single action, fixing the box to the wall at the desired depth, that is the length of the two screws. In addition, the box is held in place from inside the circular perimeter of said box, where a circular plate is inserted, which is connected to the screwdriver and the two chucks so as to hold the box in position prior to screwing. Though a spirit level connected to this plate allows the box to be perfectly aligned horizontally, being fixed in a circular site, it runs the risk of being incorrectly oriented.

DE10033598 documents a dual-chuck screwing device and two separately driven motorized screwdrivers for mounting electrical switches contained in boxes fixed to the wall. The distance between the two chucks can be regulated so as to calibrate them to different dimensions as per the design of the manufacturer of said units. The device is equipped with a spirit level to guarantee precise horizontal mounting.

Furthermore, EP 2128945 documents a device for applying electrical flush-mounted boxes into the wall and housing electrical components such as switches and power points, said device ensuring the correct position of the box unit as to the depth of the flush-mounted boxes in the wall as well as to alignment with the horizontal and the vertical axes. This device comprises an external structure equipped with supports that can be regulated to the plane of the wall, which may be rough in finish, not plastered or tiled. The flush-mounted box, which is secured from the inside by means of two sliding clamps, is held in the correct position with respect to the surface of the wall in its final state when the external surface of said plate will be installed.

The current state of technology can be substantially perfected by constructing an apparatus for mounting the support tileframes for housings containing electrical components if such apparatus overcomes the shortcomings highlighted above, thus making the mounting of the tileframe for electrical-plant housings easier, quicker and more efficient.

The technical problem at the basis of the invention herein proposed is that of constructing a suitable apparatus for mounting the support tileframe for a housing which contains electrical devices; by “suitable apparatus” is meant one which will allow the operator, in a single operation, to perform a minimum number of checks before definitively screwing the tileframe into place over the flush-mounted box fixed into the wall.

A further purpose of the invention herein proposed is that of acting simultaneously on the screws used to fix the housing while guiding the screws that fix the support tileframe.

A further purpose of the invention herein proposed is that of conferring on the device for mounting the tileframe over the housing, greater versatility in terms of the number of modular electrical accessories/devices that the housing, and hence the tileframe, can contain.

A still further purpose of the invention is that of creating a new mounting system for the tileframes and a device for holding the tileframe before screwing the screws into the housing, versatility being gained in its adaptability to the various conformations of support tileframes for the electrical accessories/devices supplied by their manufacturers.

### SUMMARY OF THE INVENTION

This problem is solved by the invention herein proposed by an apparatus for mounting support tileframes for electrical devices which comprises a mechanism to hold the tileframe still, either by means of a component inserted into the tileframe or guided onto the tileframe by the user; two or more chucks, corresponding to the number of screws to be inserted in fixing the tileframe, each of which is equipped with an insert so as to hold and guide the rotation of one of the screws; and in which the chucks are powered simultaneously in the same direction, so as to tighten the two screws or loosen them, using an electric screwdriver that can be temporarily attached to the apparatus.

In a preferred version: the mechanism for holding the tileframe acts on the inside edge of the said tileframe.

In another version: the mechanism for holding the tileframe comprises a replica of the electrical devices, dummy sockets, or at least the outer edges of the electrical devices mounted on the tileframe, in order to guide the tileframe into the correct position, said replicas or dummies being to guide a tileframe intended by the manufacturer to accompany those single electrical devices intended by said manufacturer to be mounted on said tileframe.

In addition a specific version: the mechanism for holding the tileframe comprises a a flexible element that can be compressed and expanded in order to grip the inner edge of the tileframe to be mounted.

Moreover, as an alternative, a preferred version in which: the mechanism for holding the tileframe comprises a pair of expandable jaws, each equipped with a tooth at its end so as to secure its grip on the inner edge of the tileframe.

In addition, a preferred perfected version comprises a mechanism for holding the tileframe which is provided with a pair of expandable jaws that can be regulated sideways so as to calibrate the distance between them in order to secure the hold on tileframes whose size varies dependent on the number of electrical devices said tileframes accommodate.

Further still, in a design variation: more than two chucks are present on two different levels with respect to the inner edge of the tileframe in order to guide more than one pair of fixing screws in the tightening/loosening phase.

Even still further, in a perfected design version: combined with the apparatus and aligned therewith a spirit level for checking, during the tightening of the screws, that the position of the tileframe is correct with respect to the horizontal.

In a final design variation: the mechanism for holding the tileframe comprises a mock mask to grip on the external edge of the tileframe, which must be mounted, similar to and in tandem with the attachments of the outer mask provided by the manufacturer of the tileframe itself.

In a further modification, an electric screwdriver forms an integral part of the apparatus, either directly mounted on the apparatus or supplied with the apparatus and included in the package.

The features and benefits of the invention here presented, an apparatus for mounting support tileframes for electrical devices, will become apparent from the following descriptions of certain design models, descriptions which are illustrative rather than exhaustive, and which accompany the fifteen drawings attached.

### BRIEF DESCRIPTION OF THE DRAWINGS

FIG. 1 represents a prospective and schematic view of an apparatus for mounting support tileframes for electrical devices as per the invention, said apparatus being in its first design form and without its cover so as to reveal its internal workings;

FIG. 2 represents a schematic side view of the apparatus in FIG. 1 in which a tileframe is held in position for screwing, here the screws not being shown;

FIG. 3 represents a schematic view in plan of the apparatus, as per the invention, seen in the previous figures;

FIG. 4 represents a schematic view, in perspective and enlarged, of the apparatus in the previous Figures, as per the invention, here depicting only the mechanism for holding the tileframe in position;

FIG. 5 represents a schematic axial section of a chuck for rotating the part inserted into the screw, as per the invention, said chuck being equipped with an element flexible to pressure and axially mobile so as to adjust the said inserted part in the chuck;

FIG. 6 represents a schematic axial section of a chuck, as in FIG. 5, here designed with a compression spring interposed between the inserted part and the body of the chuck;

FIG. 7 represents a schematic side view in perspective of the mechanism for holding the tileframe in position, as per previous Figures depicting the apparatus, and without said tileframe;

FIGS. 8 and 9 represent schematic views in plan, rear and side, of the mechanism for holding the tileframe, as per the apparatus in FIGS. 1 to 4 and 7 above, and, as in FIG. 7, without the tileframe;

FIGS. 10 and 11 represent schematic side views of the mechanism for holding the tileframe, in the position for inserting the tileframe (FIG. 10), and for securing the hold from the inside of the tileframe (FIG. 11);

FIG. 12 represents a schematic side view of an apparatus with a mechanism for holding the tileframe similar to that in FIGS. 1-4 and 7-11 as above but held from the outside of the tileframe: the upper and lower edges of the grip being roughened or provided with surfaces that give greater purchase on the upper and lower edges of the tileframe;

FIG. 13 represents a schematic view in perspective of a second design form for an apparatus for mounting support tileframes for electrical devices as per the invention, in which the device for holding the tileframe comprises a means of expansion, guided by a lever on the handle, which grips the tileframe to be mounted from the inside;

FIG. 14 represents a schematic side view of the apparatus in the design version outlined in FIG. 13;

FIG. 15 represents a schematic view of the apparatus in plan, here without the screwing mechanism, as per previous Figures;

FIG. 16 represents a limited schematic axial section XVI-XVI of FIG. 15 preceding;

FIG. 17 represents a perspective and schematic view of a third design version for an apparatus for mounting support tileframes for electrical devices, as per the invention, in which the device for holding the tileframe comprises a magnetic attachment which is placed inside the tileframe to be mounted and held in position with respect to the apparatus by the magnetic attraction exerted by magnets permanently housed in said apparatus;

FIG. 18 represents a schematic view in plan of the apparatus depicted in FIG. 17 above;

FIG. 19 represents a limited schematic axial section XIX-XIX of FIG. 18 above;

FIG. 20 represents a schematic view in perspective of a fourth design for an apparatus for mounting support tileframes for electrical devices, as per the invention, in which the device for holding the tileframe comprises a replica or dummy of the electrical accessories/devices housed in the unit to be mounted, so as to hold the tileframe in position with respect to the apparatus;

FIG. 21 represents a schematic view in plan of the apparatus in FIG. 20 above;

FIG. 22 represents a limited schematic axial section XXII-XXII of FIG. 21 above;

FIG. 23 represents a front schematic view of a tileframe for mounting three electrical accessories/devices, which is the form most commonly used;

FIG. 24 represents a schematic view, analogous to the previous Figure, for mounting four electrical accessories/devices;

FIG. 25 represents a schematic view, analogous to that in the preceding Figure, for mounting only two electrical accessories/devices;

FIG. 26 represents a schematic view in perspective of an integrated device for inserting standard screws in tileframes, fixing them to the units on which they must be mounted;

FIG. 27 represents a schematic view from the side of the apparatus in the previous Figure, complete;

FIG. 28 represents a partial schematic section of screwdriver seen above in FIG. 27: part of the internal transmission can be seen, as can part of the oscillating pin from the device holding the tileframe to be screwed in;

FIGS. 29 to 31 represent a front view of the screwdriver, showing the sideways adjustment of the mechanism for holding the tileframe from the inside; this is in order to align the reciprocal distances between screw-holes in the housing with those in tileframes made by different manufacturers, or also in tileframes by the same manufacturer, but with screw-hole configurations that vary between the tileframe and the electrical accessories and devices;

FIG. 32 represents a front perspective view of the apparatus in FIGS. 26-31 above;

FIG. 33 represents a front perspective view, as in the previous Figure: the slide on the device for holding the tileframe is here seen separated from the runner that allows oscillation for horizontal positioning, as when the screws are being tightened;

FIGS. 34 and 35 represent schematic views of the tileframe's slide from the inside of the box containing the electrical accessories/devices;

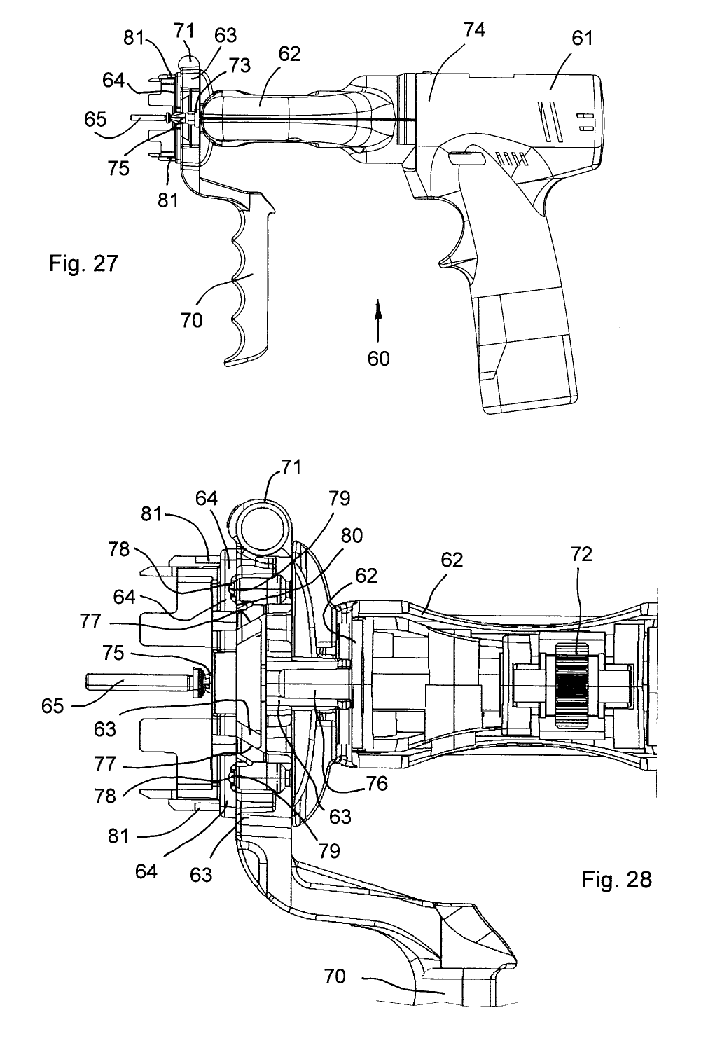

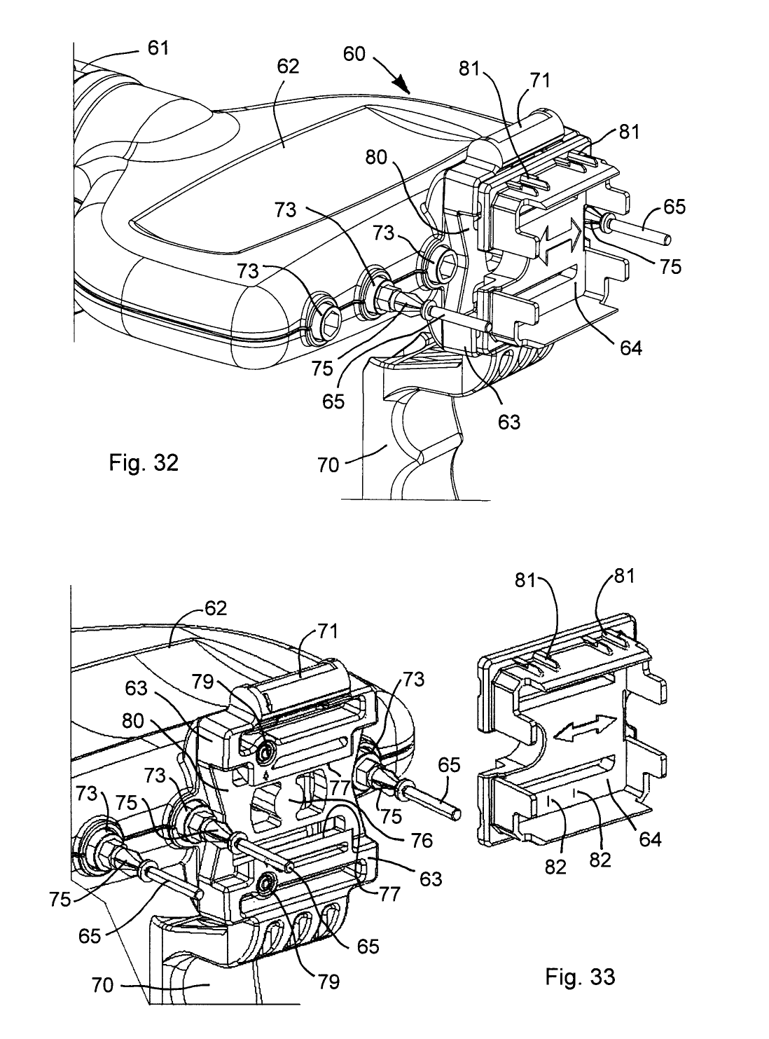

finally, FIG. 36 represents a schematic section of a flush-mounted box in the wall so as to house the electrical accessories/devices, over which the support tileframe is screwed by means of the screwdriver in FIGS. 26-35 above.

### DETAILED DESCRIPTION OF PREFERRED EMBODIMENTS

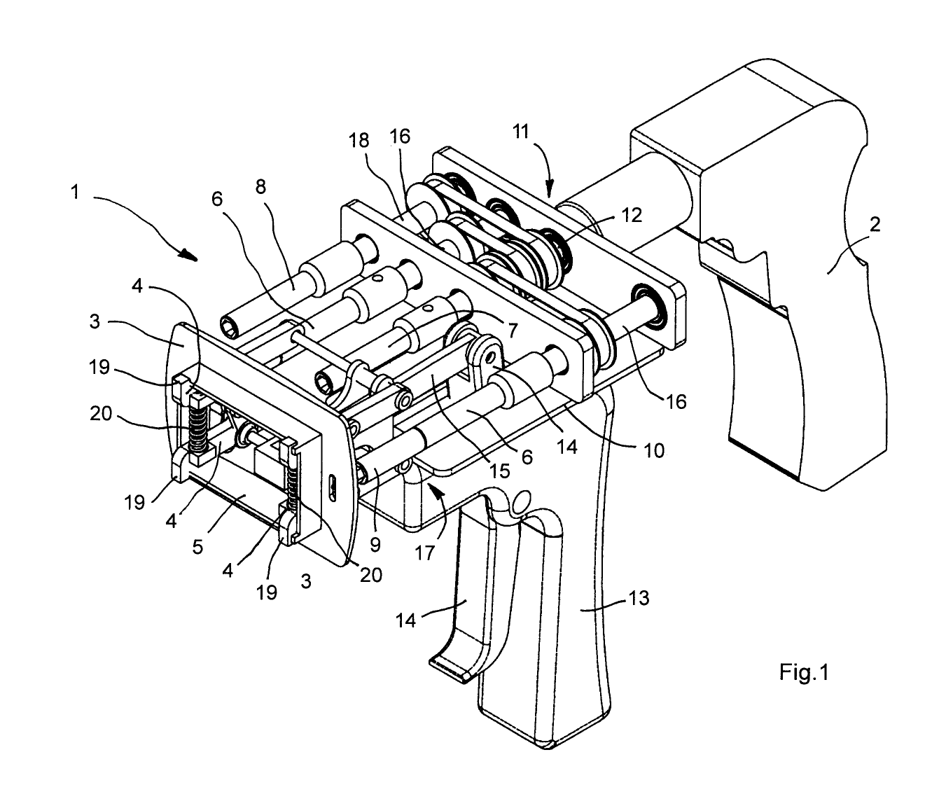

In FIG. 1 an apparatus 1 can be seen, as per the invention herein presented, equipped with a screwdriver 2 mounted on the apparatus, which is in turn equipped with a device for holding the support tileframe 3 for electrical accessories; in the said device two pairs of jaws 4 are inserted inside the tileframe 3 and opened, making it possible to grip the tileframe's inner surface 5 and hold it while a pair of chucks 6, one for each screw to be tightened, fixes the tileframe in position. The apparatus is further equipped with an intermediary chuck 7, additional to those mentioned, for tileframes whose screws are placed closer together, and an outer chuck 8 for tileframes 3 with screws placed further apart, as depicted: these chucks do not have inserts for (un)tightening screws, whereas the previously mentioned chucks 6 do have an insert 9 for (un)tightening the screw on the tileframe 3. The frame 10 of the apparatus 1 features a transmission 11 for the rotational movement from the motor cam 12 inserted into the screwing mechanism 2 at each chuck 6, 7 or 8, so as to set them in rotation simultaneously and in the same direction. The transmission 11 comprises, advantageously, belts that are wound around pulleys on the drive shaft 12 and on each shaft 16 or 18, guided by a chuck so as to set the chucks themselves in quasi synchronous rotational motion. The chuck 7 is connected directly to the drive shaft 12. In the handle 13 held by the operator there is a lever 14 which controls the opening of the jaws 4 in such a way that said lever, when activated, acts with a piston rod 15 on the command mechanism 17 so as to open the teeth 19 on the jaws 4, whereas the spring 20 ensures the hold of the tileframe 3 even when the lever 14 is not squeezed by the user.

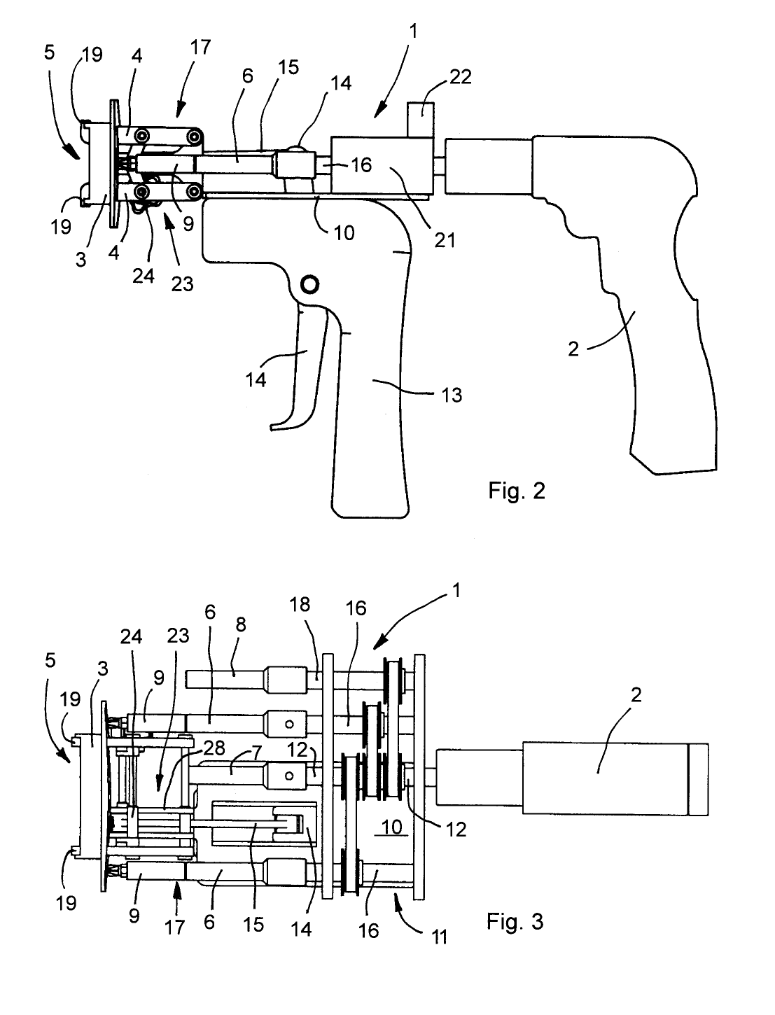

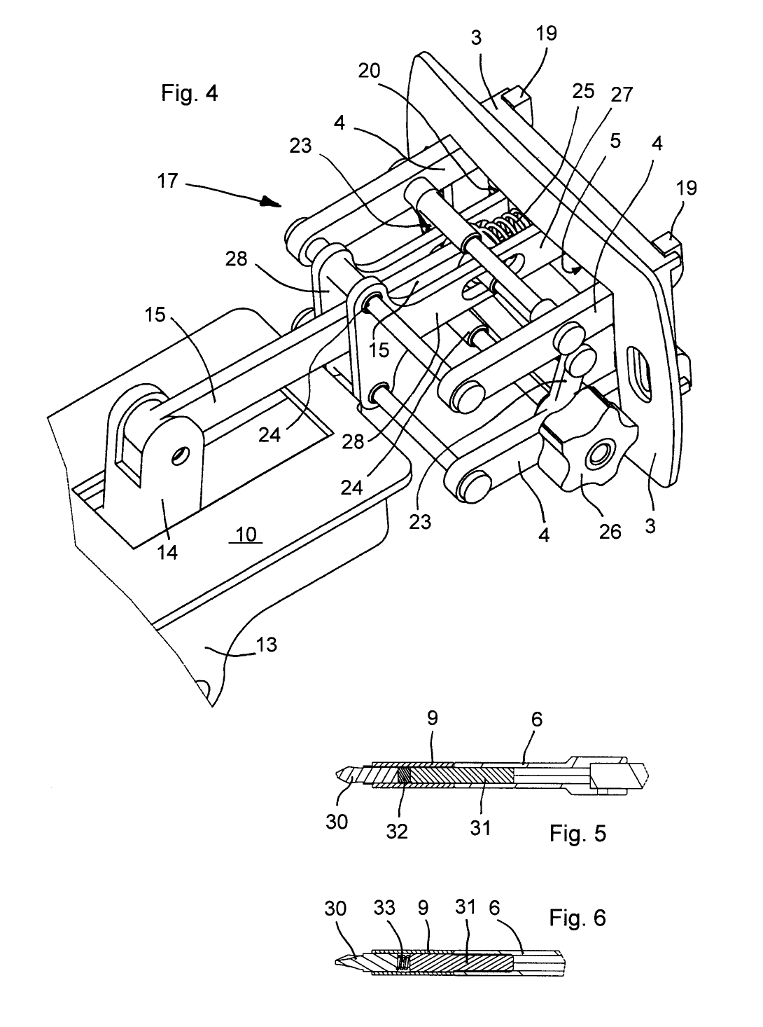

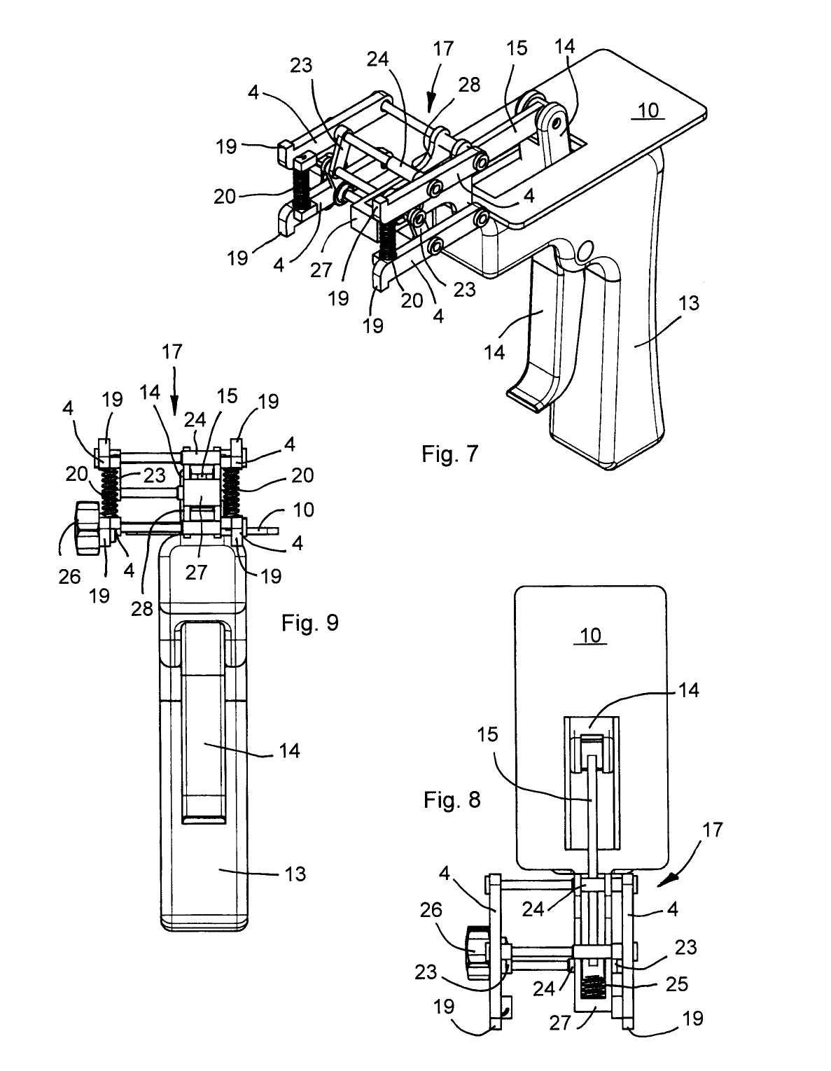

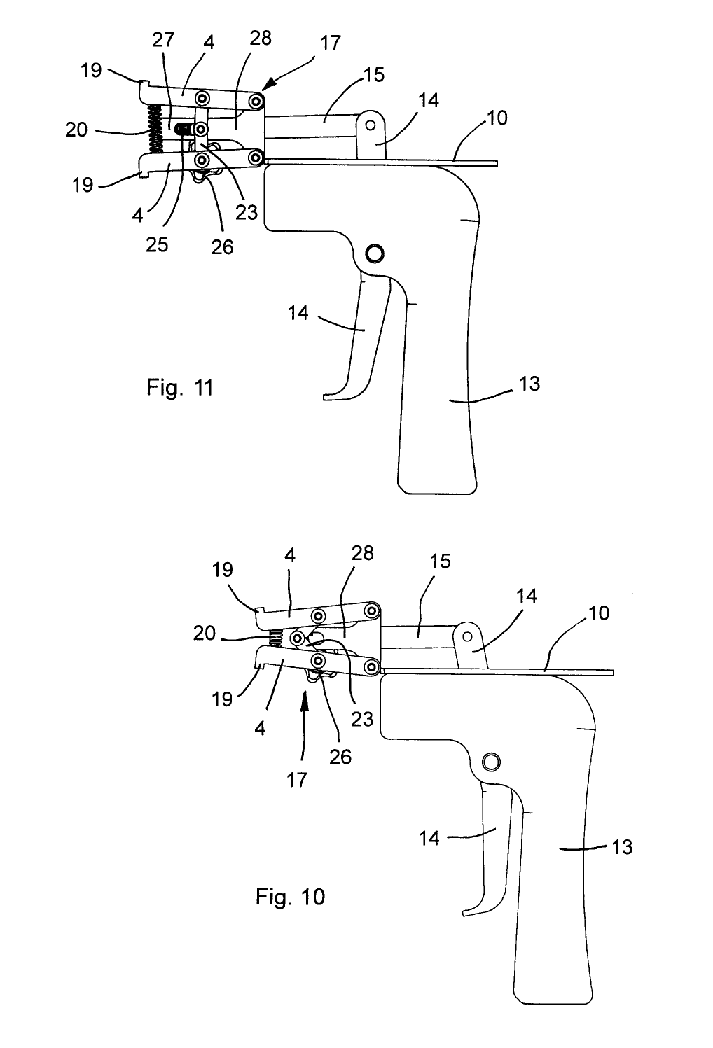

In FIGS. 2-4 and 7-11 which follow can also be seen: the cover 21, which covers the transmission 11 of the apparatus 1, on which a spirit level 22 is mounted indicating, while screws are being tightened, the position of the apparatus with respect to the horizontal; in addition, a lever system 23, for activating the jaws 4 either when releasing or blocking the tileframe 3, and 24 for the sideways regulation of one jaw with respect to the other, adapting the width to the specific size of the tileframe, said tileframe having two or more places for housing the electrical accessories/devices. Thus the lever system 23 acts upon the jaws 4, bringing them closer together if the lever 14 is activated by loading a spring 25, whereas the opposite occurs when the piston rod 15 is advanced; said spring exerting a counterforce against a terminal contact 27 in the structure 28 of the command mechanism 17. On one side of a jaw 4, a winder head 26 is present to block the lever system 23 to the desired jaw 4 aperture, either side of the inner surface 5.

In the sections of FIGS. 5 and 6, the insert 9 tips 30 can also be seen, which act on the screws, generally with a Philips head; a hexagonal pin 31 allows the insert 9 to be inserted in a chuck, here 6, even if the other chucks are mounted analogously; finally, between the hexagonal pin 31 and its respective tip 30 an element 32 fashioned in a soft and flexible material is inserted so as to allow the tip to perform an axial motion with respect to the hexagonal pin 31 in FIG. 5, while in FIG. 6, in order to make the said axial motion possible, a compression spring 33 is provided.

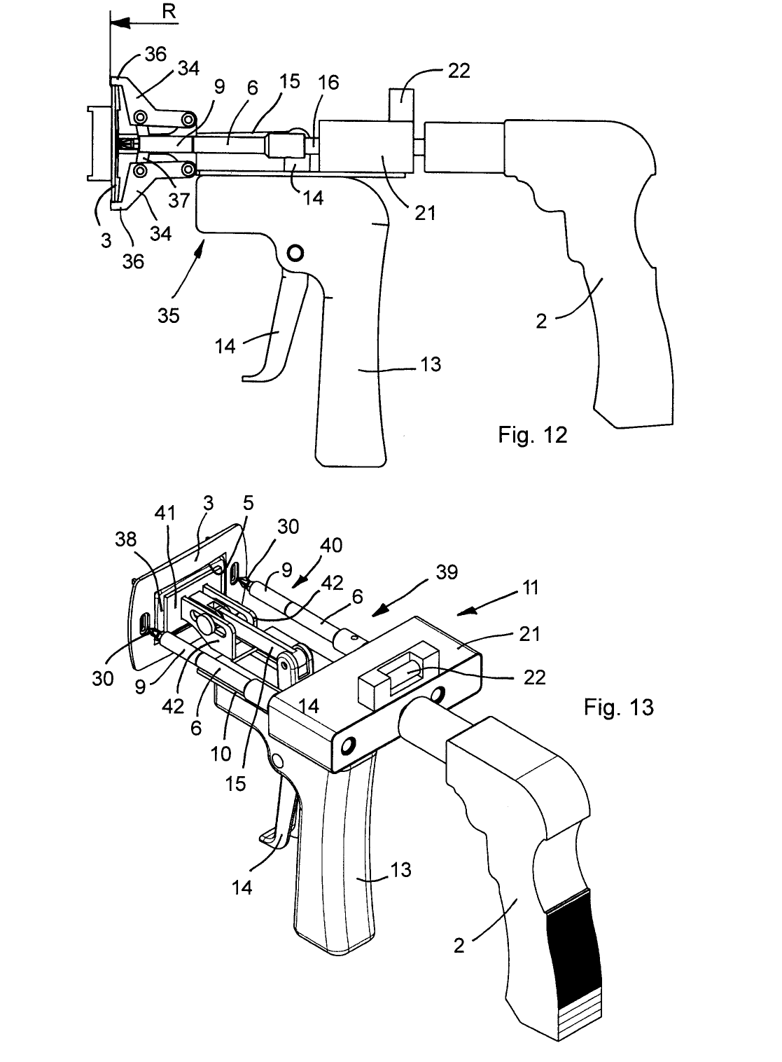

In the design version in FIG. 12, a variation on the previous design which features the jaws 34, the apparatus 35 secures its hold on the tileframe 3 from the outside surface; it is provided with teeth 36, which advance as far as the tileframe's 3 inner plane R, thus ensuring a tight fit against the wall on which it is mounted. The lever 14 acts on the lever system 37 to open and close the jaws 34 and their respective teeth 36, with the action of the piston rod 15 and against the spring 25, which is not visible in the Figure, thus securing or releasing the tileframe 3 while the apparatus 35 is in use.

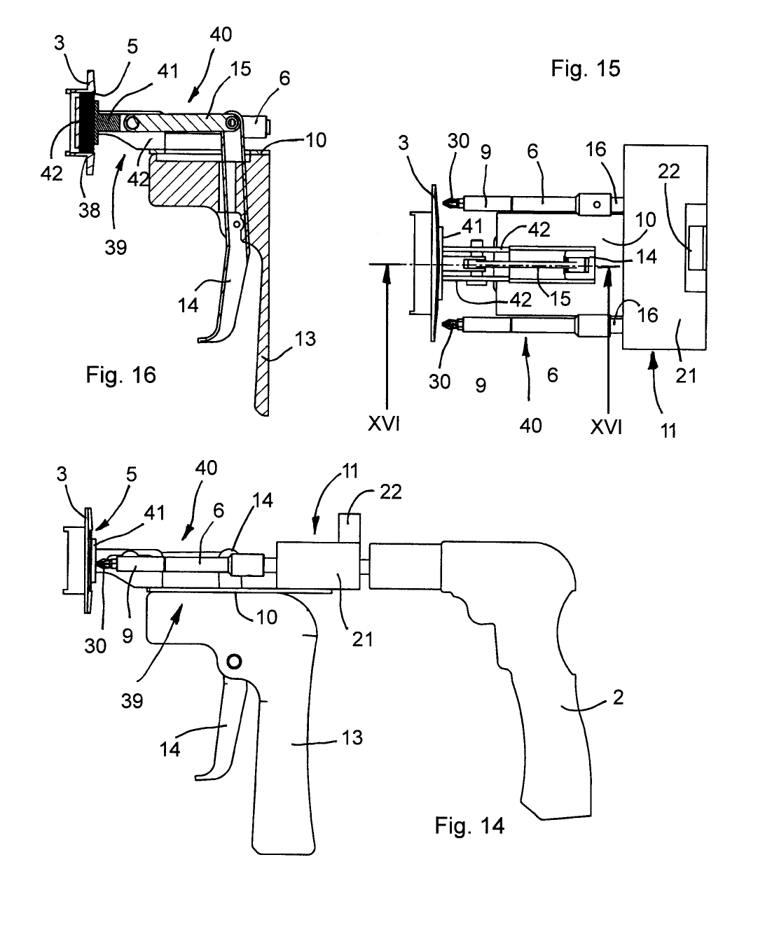

In the design version in FIGS. 13 to 16, a compressible and expandable flexible element 38 is inserted for securing the tileframe 3 by its inner surface 5 in such a way as to hold it still with respect to the apparatus 39, which is provided with transmission at the chucks 6, similar to the previous design versions, and a lever system 40, for activating the said compressible and expandable element 38. Blocking the compressible and expandable element is achieved by advancing the piston rod 15, activated by the lever 14, which acts with the device exerting pressure 41, while the mechanism's structure 42, which is connected to the body 10 of the apparatus, resists this movement by applying pressure; thus the outer edge of the compressible and expandable element 38 exerts pressure on the inner edge 5 of the tileframe 3, which is to be mounted in the desired position.

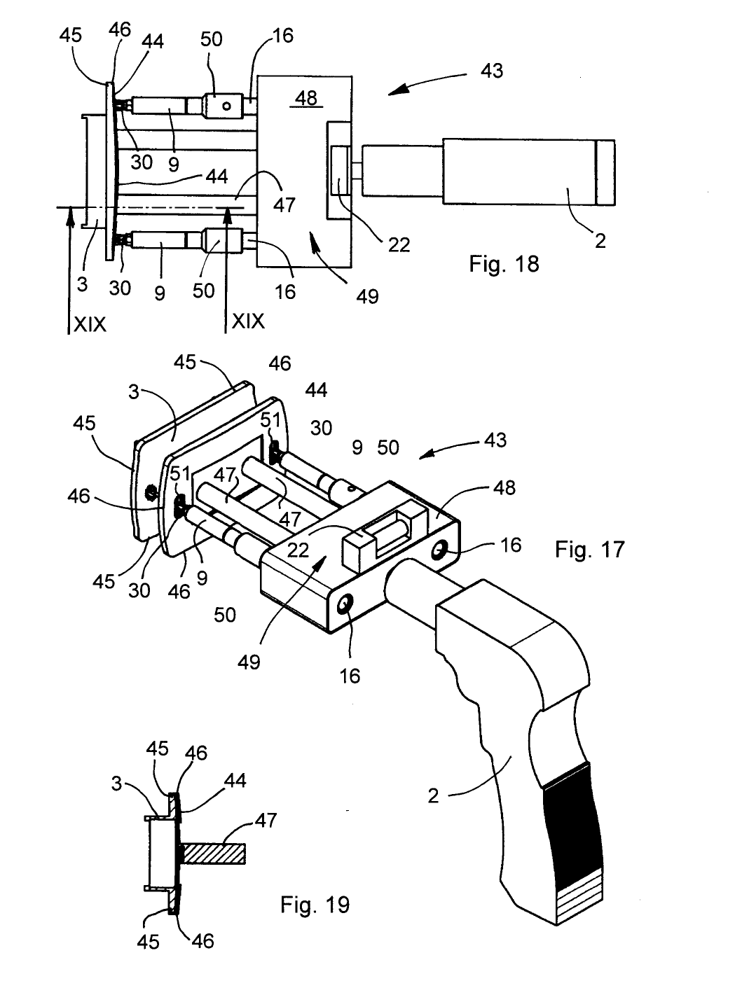

In the design version in FIGS. 17 to 19 the apparatus 43 is equipped with a mock mask 44 for holding the tileframe 3 in position, said mock mask simulating the mask of the final decorative effect. As is usual for a mask of this kind, the mock mask 44 is held on the external edge 45 of the tileframe 3 with the inner surface 46 of the mock mask, here used to guide the tileframe into position when the screws are being tightened on the box itself. The mock mask is positioned on the apparatus 43 by means of the arms 47 connected to the body of the apparatus 48. The body comprises a transmission 49, analogous to 11, but limited to only two chucks 50, given the need to use a specific mock mask based on the type and size of tileframe. The mock mask contains holes 51 through which the screw heads pass and which must be tightened with the relative tips 30.

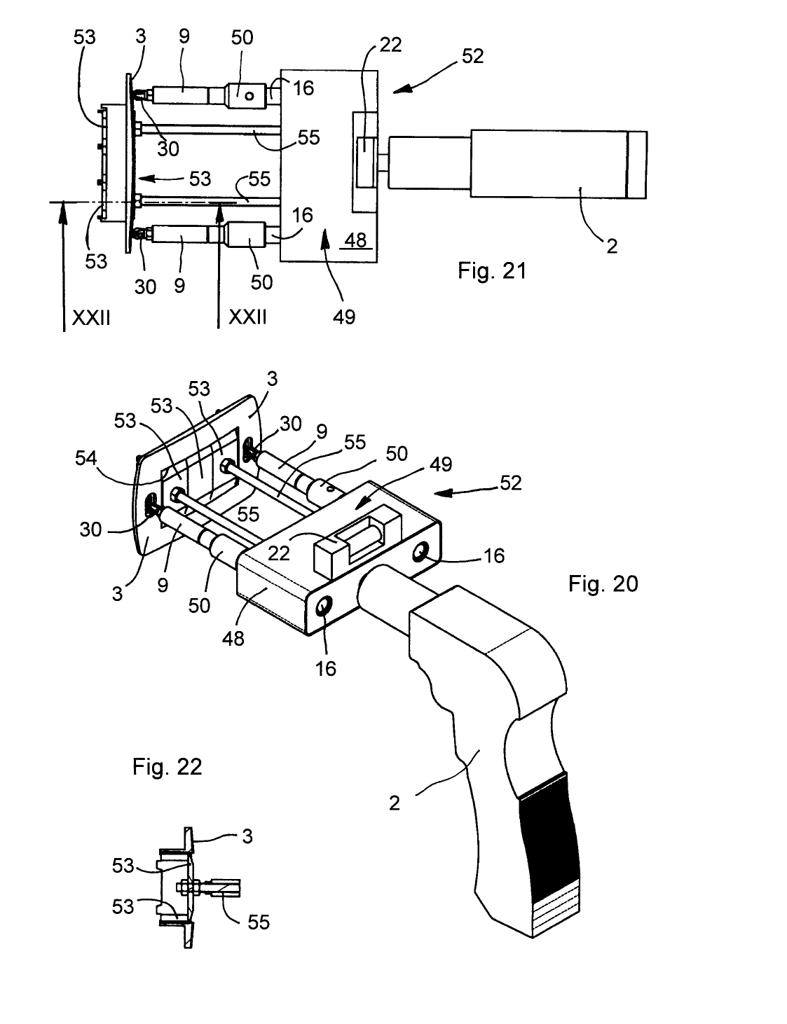

In the design version in FIGS. 20 to 22 the apparatus 52 is equipped with a number of dummies 53 or replicas which correspond to the electrical accessories/devices housed in the tileframe 3 being mounted. In FIG. 20 there are three dummies housed inside the tileframe 3, but inserted in such a way as to be extractable after the tileframe 3 is mounted. The tileframe 3 is precisely secured, but not blocked, on the inner surface 54, the said replicas 53 having the same outline of each of the electrical devices whose shape and size they replicate. Thus, when the screws are being tightened on the box itself, the tileframe is guided by the outer edges of the replica 53, which are not blocked on the inside edge 5 of a tileframe 3 as would be the case with the electrical accessories/devices they replicate. The replicas 53 are positioned on the apparatus 52 by means of rods 55 connected to the body of the apparatus 48, which in this case is analogous to the shape of the apparatus depicted in FIGS. 17-19 above. Thus, similarly, the body comprises a transmission 49 analogous to 11 above, but with only two chucks 50, given the need to have a number of replicas 53 based on the shape and size of the tileframe.

However, in the design version which comprises the mock mask 44 or with the replica 53 more than two chucks 50 may be present so as to give the same versatility as the version with jaws, aligned and positioned in respect of the distance between the screws on the tileframes and housing only two, or also more than three, electrical accessories/devices, as opposed to what is here depicted.

The design versions described may comprise more than two chucks so as to tighten simultaneously up to four screws, as is the case with the support tileframes for electrical devices of the new generation, which are square or rectangular. Constructing an apparatus of this kind, though it has not yet been done, presents no problems, it having not only one but two pairs of chucks, positioned so as to align with the respective fixing screws of a tileframe with four holes. The mechanism for holding the tileframe may be one of those described above, whereas transmission from the rotational motion must occur while the chucks at the upper level, as well as those at the same level, are connected, as depicted in FIG. 1. That is, as depicted, the drive-belt transmission in FIG. 1 connects the shafts of the chucks at the upper level so as to activate, when screws are being tightened or untightened, all four screws on the four-screw tileframe involved in the tightening/untightening process.

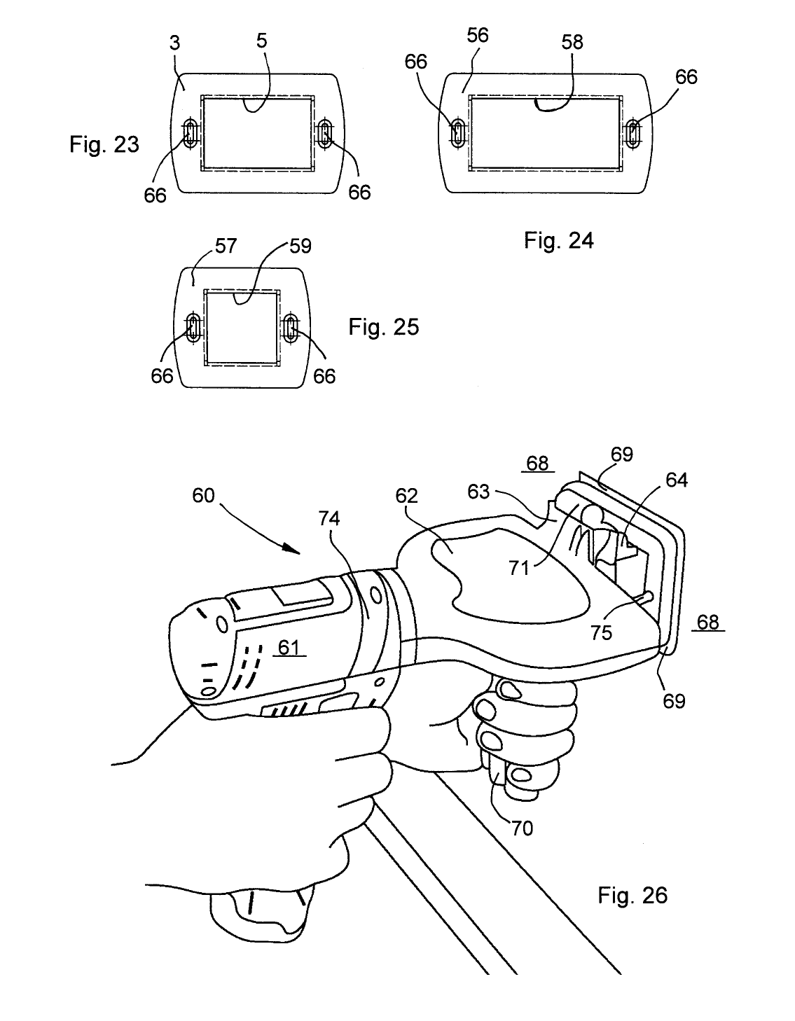

However, most boxes mounted during the installation envisage the use of tileframes similar in shape to those in FIGS. 23, 24 and 25, that is tileframes 3 with three housings with an inner surface 5, as depicted, tileframes 56 with four housings with an inner surface 58, and tileframes 57 with two housings and an inner surface 59.

Below is described the integrated version of the apparatus 60 designed for mounting tileframes and depicted in FIGS. 26-36. The integrated version comprises a tightening/untightening device 61 and is connected permanently to a transmission with multiple chucks mounted in a crankcase 62, and in which the support 63 of an adjustable stirrup 64 is made to oscillate on an axis parallel to the chucks, said device being coupled with at least two housings of one of the tileframes 3, 56 or 57 in order to ensure the hold and alignment of the chucks involved with the respective screws 65 and matching holes 66, also in FIGS. 23-25, which enable it to be adapted to the threaded holes in the electrical box 67, inserted in the wall or fixed permanently to a wall 68 in its niche 69, allowing the box to be adjusted horizontally should said box not be perfectly aligned horizontally. Oscillation for positioning the tileframe correctly with respect to the horizontal is controlled with the handle 70 and the spirit level 71, both of which are connected to the above-mentioned oscillating support 63.

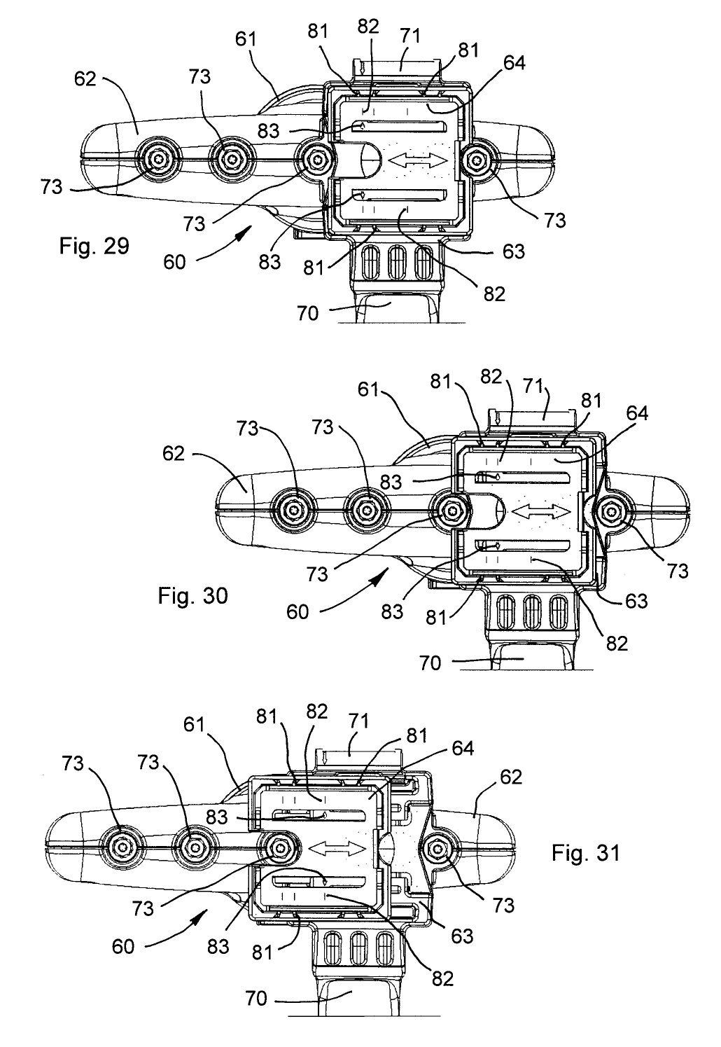

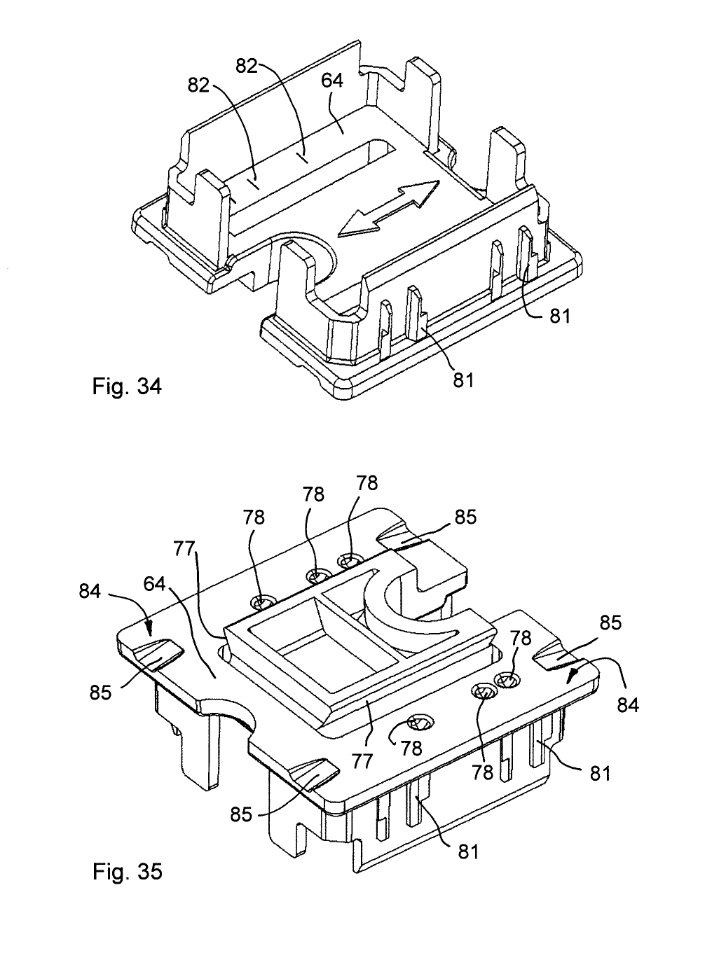

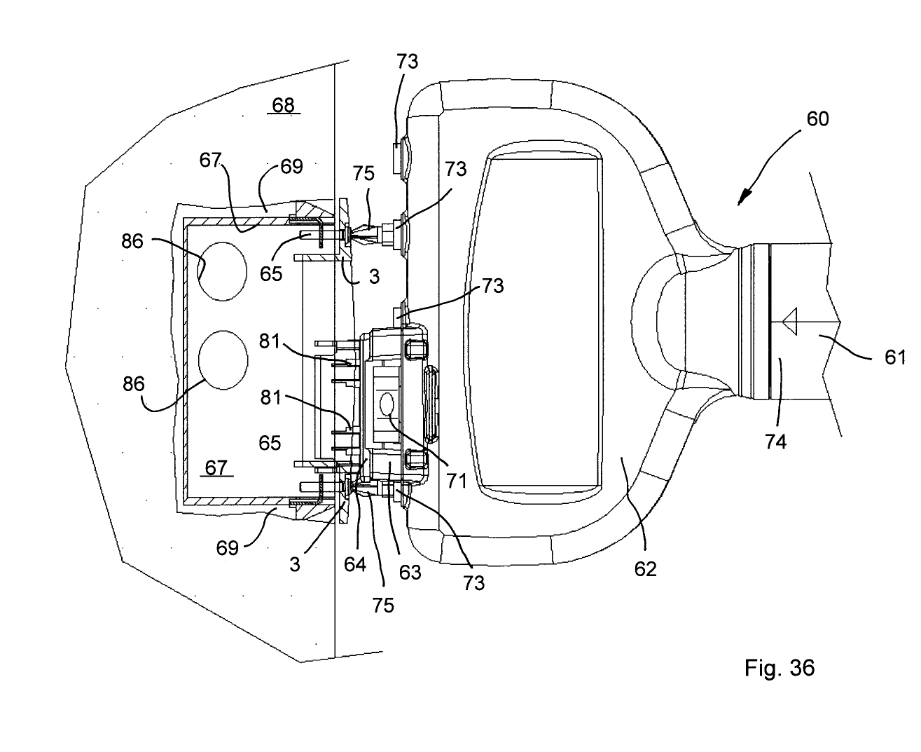

For simplicity's sake, the transmission in the crankcase 62 is geared 72 among the various chucks 73 and uses a conventional clutch coupling 74 present in the screwing device 61. Thus, each chuck 73 is provided with a screwdriver insert 75 to a standard hexagonal connection only when it needs to tighten or guide a screw 65 in the position specific to the chuck involved. The oscillating support 63 oscillates on a pin 76 connected to the crankcase 62 and the adjustable stirrups feature guidelines 77, of the adjustable stirrup 64, which run in the direction of the mean position in the arc of oscillation, made possible by the screw holes 66 and the plane in which the chucks 73, as well as the pin 76 lie, when the oscillating support presents the said median coinciding with the plane of the chucks. The adjustable stirrup 64 presents hollows 78 into which sprung bearings 79 are inserted, present on the part facing 80 the oscillating support 63. The insertion of said sprung bearings 79 allows the adjustable stirrup to be positioned at the pre-set distance depending on the kind of electrical accessory or device to be housed in the said tileframe 3. In addition, the adjustable stirrup 64 features guidelines 81 specific to coupling with housings for electrical accessories/devices envisaged by the manufacturer of the tileframe and said electrical accessories/devices. Thus, as can be seen in FIGS. 29-31, the adjustable stirrup clicks into the three positions 82 pre-set for the specific type of tileframe and electrical accessories/devices to be mounted; arrows 83 are present on the said oscillating support 63 to indicate the position reached by the adjustable stirrup with respect to the set positions. Finally, as can be seen in FIGS. 34-35, the back 84 of the adjustable stirrup features notches 85 for easing the entry of the sprung bearings 79 located on the support interface 80.

The use of the various versions of the apparatus, as outlined in the descriptions of the invention, is both simple and practical. The operator who uses the apparatus as per the invention described in its first form acts as follows. He or she presets the apparatus to the required width for the tileframe to be mounted by turning the winding head 26, setting the position of the extendable jaws 4 on the right with respect to the fixed jaws 4 on the left. He/she positions an insert 9 on each chuck 6 with the respective tip 30 for holding one of the screws, which are usually already included with the tileframes 3 to be mounted. He/she then squeezes the lever towards the handle 13, bringing the jaws 4 and the respective teeth 19 together so as to insert them inside the inner edge 5 of the tileframe 3. During insertion, each tip 30 can already be placed in connection with the screw present on the tileframe 3. When the lever 14 is released, the springs 20 force the jaws against the inside edge 5 and the spring 25 pushes the piston rod 15 and the lever system 23 backwards so as to push the jaws against the internal edge of the tileframe 3.

In a variation not here depicted the inclination of the levers in the lever system 23 can be inverted, thus reversing the blocking movement of the jaws with respect to the action on the lever 14. As depicted, the hold is ensured when the lever 14 is released; inverting the inclination of the lever system 23, in a backwards direction, the release position results in the mechanism always being ready for the tileframe to be inserted, compatible with the opposing forces between the springs 20 and the spring 25, here acting not in the same direction but in opposite directions; thus only by acting on the lever 14 can the jaws 4 be tightened and the hold on the inside edge 5 of the tileframe ensured.

The integrated version 60 operates in a similar way to that previously described in terms of activating the chucks 73 for tightening/untightening the screws 65, while offering greater versatility in adapting the hold by means of replica templates in the adjustable stirrups 64, said replica being created for a specific type of electrical accessory/device which must be mounted on the tileframes 3, 56 or 57 to be fixed to the electrical box 67, sunk into the wall, inside of which channels 86 are also sunk, invisible to the final user. Thus the guidelines for insertion 81 are positioned and/or calibrated specifically by the manufacturer of the tileframe and the electrical accessories/devices for merely commercial reasons as well as to avoid confusing their own products with those of the competition.

The tileframe 3 is thus mounted rapidly and smoothly, the adjustable stirrup 64 being extracted with the insertion pins 81 from the internal edge 5 of the tileframe. When the apparatus 60 is kept pressed against the tileframe, there is no sign whatever of the screws 65 coming undone, and said screws can be tightened or untightened as required. Moreover, in the integrated version of the apparatus 60, the degree of oscillation that the rotating pin 76, which is connected to the crankcase 62, allows the oscillating support 63, makes it possible to adjust the horizontal position of the tileframe 3 while it is being fixed, independently and with both hands engaged simultaneously in blocking the reciprocal movements between the crankcase 62 and the tileframe 3, or 56 or 57.

Finally, the relative horizontal position between the chucks 73 and the adjustable stirrup 64 is easily regulated by letting the said stirrup shift, little by little, with respect to the chucks. In this way it is possible to use the integrated version to work on the tileframes of most, if not all, manufacturers of tileframes and electrical accessories/devices.

The advantages of using this invention, an apparatus for mounting support tileframes for electrical devices, can be summarized as follows. The versions described allow the operator to position the tileframe and associated chucks with precision, thereby performing the rotational operation of more than one screw at the same time, the tightening or untightening of said screws being quick and safe, without the need to position a screwdriver or electrical screwdriver manually for each screw. Moreover, the version with jaws, whether the tileframe is held on the inside or outside edge, proves very practical and versatile, being adaptable to all kinds of tileframes produced by manufacturers, even if they are incompatible in terms of the way they block the electrical accessories/devices that are mounted in them. The versions which include dummy replicas 53 or those with mock masks 44, are more suitable to familiarizing the operator since the dummy replicas 53 and mock masks 44 are designed on the basis of the specific dimensions of the tileframes being mounted. Each manufacturer, moreover, constructs support tileframes for electrical accessories/devices in different sizes and with different methods of mounting, or constructs the outside edge of the tileframe so as to make it suitable to particular designs of cover masks in the finished product, where the visible mounted wall unit forms part of a specific furnishing designs. In this way, the various versions of the apparatus described in the present invention may be multiple even for a single manufacturer of electrical accessories/devices.

In a single mechanical design solution, the integrated version of the apparatus 60 resolves the complexity of different sizes and modes of insertion 81 created by various manufacturers, allowing the operator to manage the problems of compatibility between the various series of electrical accessories/devices. This complexity is due partly to the desire of manufacturers to combine the said accessories/devices with their own tileframes, and partly aimed at preventing the combination of accessories/devices from other firms on the same tileframes. The design version here proposed overcomes the disadvantages of this situation, in which it is often difficult for the operator to normalize working procedures.

The apparatus for mounting support tileframes for electrical accessories/devices as proposed in this invention thus proves beneficial firstly because certain of the design versions make the apparatus versatile for all kinds of support tileframe, even from different manufacturers, but also, secondly, because other design versions can limit the apparatus to use with particular types of tileframe specified by the manufacturer of the said apparatus.

Obviously, the apparatus for mounting support tileframes for electrical accessories/devices as described above may be subject to numerous modifications made by a technical expert in the field in order to meet specific contingent requirements, all of which would fall within the protection claims of the present invention outlined below. Thus, albeit less advantageously in terms of cost and ease of use compared with the above description, other variations in the apparatus for mounting support tileframes are indicated below. Thus, a clutch mechanism can be inserted in each chuck so as to limit the couple rotation in the tightening of each single screw. In addition, the mechanism used by the apparatus for inserting or holding the tileframe might comprise specifically dedicated sites or holes for said operations: in this way a manufacturer of electrical accessories/devices might standardize the system for a single type of apparatus, still maintaining, however, the differentiation in production as regards size and the external surface of the tileframe. Moreover, the replicas of electrical accessories/devices here described might be blocked in their site on the tileframe and extracted with a lever controlled externally and used in association with the apparatus in such a way as to allow the user to control the hold or release of the tileframe. Furthermore, the screwing device might be provided with a specific attachment, that cannot be standardized and thus not replaced: the apparatus proves versatile but with a dedicated screwing device, that is the apparatus can only work with the electric screwdriver intended for this specific purpose. Thus also, the replicas and templates in the version with the integrated screwdriver 60 as described above might be replaced by any of the modes and mechanisms for holding the tileframe described above, in association with the oscillation of the crankcase 62 mechanism. Finally, the rotational motion might be generated by a manual mechanism, that is with a handle or hand-wheel acting directly on the transmission of the motion to the respective chucks of the apparatus featured in this invention.

1. An apparatus for mounting support tileframes for electrical devices over a housing, the apparatus comprising:
a mechanism for holding the tileframe inserted in the tileframe or guided for holding the tileframe by the user;
two or more chucks whose number varies according to the number of screws used to fix the tileframe, each being equipped with an insert for holding and directing the rotation of one of the screws, the chucks being activated simultaneously in the same direction, either for fixing the screws or for unscrewing them with a screwdriver which can be temporarily fixed to the apparatus;
a spirit level so as to verify, at the moment of fixing the screws, that the tileframe is correctly positioned horizontally,
wherein the mechanism for holding the tileframe is adjustable in accordance with a number of modular electrical accessories/devices that the housing, can contain.

2. The apparatus, according to claim 1, wherein the mechanism for holding the tileframe) acts on the inside of the internal surface of said tileframe.

3. The apparatus, according to claim 2, wherein the mechanism for holding the tileframe includes a look-alike of the electrical device, or dummy poles, at least for when the electrical devices are in the side mounted positions on the tileframe, for guiding the tileframe into the correct mounted position, said look-alikes being positioned with the attachment provided with the single electrical device by the constructor of the tileframe and of the electrical devices that are to be mounted on said tileframe.

4. The apparatus, according to claim 2, wherein the mechanism for holding the tileframe includes a compressible and expandable flexible element, for securing the inside of the internal edge of the tileframe to be mounted.

5. The apparatus, according to claim 2, wherein the mechanism for holding the tileframe includes expandable jaws each of which features a tooth at one end with which the internal surface of the tileframe is held.

6. The apparatus, according to claim 5, wherein the mechanism for holding the tileframe is provided with a pair of jaws that can be regulated laterally with a regulator, which can set the distance between the said jaws which are expandable so as to improve the hold on the electrical devices according to the number of said devices that the tileframe must accommodate.

7. The apparatus, according to claim 1, wherein two or more chucks are present on two different levels of height with respect to the internal edge of the tileframe so as to guide in screwing/unscrewing more than one pair of screws to be fixed.

8. The apparatus, according to claim 1, wherein the rotational motion might be generated by a manual mechanism, that is with a handle or hand-wheel acting directly on the transmission of the motion to the respective chucks of the apparatus featured in this invention.

9. The apparatus, according to claim 1, wherein the holding mechanism includes a mock mask of grip on the external edge of the tileframe, which must be mounted in the same way and in tandem with the attachments provided by the constructor of the tileframe itself.

10. The apparatus, according to claim 1, wherein an electrical screwdriver is mounted as an integral part of the apparatus itself or is provided separately in the package made commercially available.

11. The apparatus according to claim 2, wherein the apparatus is permanently connected with the screwdriver and the mechanism for holding the tileframe comprises an adjustable stirrup on an axis horizontal and parallel to the plane of the chucks to tightening the screws that holds replicas, or dummy poles; the spirit level is visible by the user and placed on an oscillating support with the stirrup, embody the holding mechanism to reach the right horizontal mounting.

12. The apparatus, according to claim 1, wherein an adjustable stirrup, comprises two replicas, or dummy poles, is slidable in direction parallel to the plane of the chucks of tightening the screws.

13. The apparatus, according to claim 11, wherein the adjustable stirrup, comprises two replicas, or dummy poles, is replaceable to adapt guidelines specific to coupling, on seat of tileframe, with housings for electrical accessories/devices envisaged by the manufacturer of the said electrical accessories/devices to be mounted.

14. The apparatus, according to claim 1, wherein the apparatus is permanently connected to a screwdriver and the holding mechanism of the tileframe comprises a mock mask made on a oscillating stirrup on an axis horizontal and parallel to the plane of the chucks to tightening the screws; the spirit level is visible by the user and placed on an oscillating support with the stirrup embody the holding mechanism to reach the right horizontal mounting.

15. The apparatus according to claim 1, wherein the holding mechanism is held in a stirrup that is adjustable on an axis horizontal and parallel to the plane of the chucks to tightening the screws; the spirit level is visible by the user and placed on an oscillating support with the stirrup embody the holding mechanism to reach the right horizontal mounting; the apparatus being provided with a clutch limiting the torque tightening the screws, singularly each chuck or on a connection shaft with an external screwdriver.
